(19) United States
(12) Patent Application Publication
(10) Pub. No.: US 2018/0068336 A1
(43) Pub. Date: Mar. 8, 2018

(54) SYSTEM AND METHOD FOR DEVELOPING DISCOUNT PROGRAMS

(71) Applicants: Scott Yardley, Long Beach, CA (US); Scott Brownsberger, Hermosa Beach, CA (US)

(72) Inventors: Scott Yardley, Long Beach, CA (US); Scott Brownsberger, Hermosa Beach, CA (US)

(21) Appl. No.: 15/698,367

(22) Filed: Sep. 7, 2017

Related U.S. Application Data
(60) Provisional application No. 62/384,684, filed on Sep. 7, 2016.

(51) Int. Cl. G06Q 30/02

(52) U.S. Cl. CPC G06Q 30/0211; G06Q 30/0225

(57) ABSTRACT

A method for developing discount offers to consumers on a network is provided. The method is executed by one or more computing processors and computer hardware and describes receiving, at a server, at least an input at a from each of a merchant client in communication with the server over the network, a merchant finder client in communication with the server over the network, generating a unique identification code for the merchant finder client in response to the input from the merchant finder client, outputting the unique identification code to the merchant finder client, generating an interface for the merchant client, the interface configured to allow a merchant to establish and optimize a discount offer for the consumer, upon a purchase of the discount offer by the consumer, receiving the unique identification code, assigning a value to the merchant finder client based on the purchase. A system of developing discount offers is further provided.

### CROSS REFERENCE TO RELATED APPLICATION

This application claims the benefit of U.S. Provisional Application No. 62/384,684, entitled A System and Method for Optimizing Discount Offers, filed on Sep. 7, 2016.

### FIELD OF THE INVENTION

The present invention relates generally to dynamic networking and mobile application-based identification of deals and rewards, and the creation of a referral-based crowd sourced purchasing cooperative. More particularly, the invention relates to a system and methods for the quantitative processing, facilitation and implementation of reward programs which are optimized based on predetermined and real-time inputs, while concurrently optimizing merchant discount offers based on those inputs, such that merchants utilizing the system are sourced by other users of the system. The invention is further directed towards certain new and useful advances in geo-fencing as it relates to a crowd-sourced purchasing cooperative.

### BACKGROUND OF THE INVENTION

While the retail industry has seen a downturn in sales made through “brick and mortar” retail shops—namely, those engaged in the sale of products from physical locations that warehouse and display merchandise with the intent of attracting customers to make purchases on site—the industry continues to flourish through the use of non-store retailers—namely, those engaged in the sale of products using marketing methods that do not include physical location, such as mobile-only retailing and Internet-only e-commerce—global retail sales were more than $22 trillion in 2014, according to a report from eMarketer.com. In 2015, global retail sales were expected to reach $24 trillion. Within the United States alone, total annual retail sales have increased an average of 4.5% between 1993 and 2015, according to the U.S. Census Bureau.

In addition, discounts are an integral part of retail strategies, regardless of whether one operates a traditional brick and mortar business or a non-store business. Merchants rely upon discounts for a plurality of reasons, such as to promote new and existing goods and/or services, to increase the sales of that good and/or service, or to increase the sales of the merchant's other goods and/or services. Furthermore, much like merchants, consumers also rely upon discounts to reduce their spending—this reliance is heightened for families, especially during times of economic hardships.

Traditional methods of offering discounts include providing coupons and rebates to potential customers, but these methods have several disadvantages, such as fraud and low consumer participation. While low consumer participation may be good for the immediate top line of the merchant, the long-term effect is that consumers lose faith in rebate programs and do not see rebates as an actual “discount,” with the argument being that they will either never submit the rebate, be too late to submit the rebate, or that the rebate will simply take too long to be received, thus not giving them the instant gratification you would receive from being provided an instantaneous price cut. More importantly, rebate programs still require the consumer to output a higher price in hopes of receiving the rebate, thus not providing the consumer in any instant and measureable discount. Furthermore, fraud is an issue as coupons may be copied and with the advent of mobile coupons, many store employees will take coupons presented on a mobile device that are not valid; fraud with rebates are also an issue as consumers attempt to claim rebates for goods and/or services they have never actually purchased or after the deadline has passed.

Furthermore, these methods of deal-finding and coupon distribution relied heavily on newspaper inserts, direct mail, television advertisements, magazines, and more recently, e-mail and web advertisements. These past approaches utilize a traditional “scatter gun” or “canvassing” approach, rather than precise targeting. As such, it is often the case that the rebates and/or coupons end up with consumers who have no interest or need for the good and/or service offered under the coupon or rebate program. In addition, advertising and marketing costs are often expensive and cost prohibitive when done through the use of television as the medium. However, the development of the Internet, wireless protocol and mobile applications have given consumers the ability to locate deals, “price shop” and utilize loyalty rewards in a more robust way than ever before.

For example, some deal-finding websites employ a team of deal hunters who keep their eyes on millions of products from reputable online retailers and update the site with new deals hundreds of times a day. A user can sign up for e-mail alerts for products or stores they're interested in and get advice from the site's buying guides.

Other deal-of-the-day websites utilize group buying power and provide local deals that offer savings for consumers while delivering higher sale numbers to participating merchants. Most local group coupon sites offer a short-term “daily deal coupon” that offer discounted goods and/or services, usually selling out of such offerings within just a few hours. The most prominent group buying site, Groupon®, has been successful with its once-a-day deals selling hundreds of millions of coupons each year.

However, even those systems that rely on certain inputs from a user do not sufficiently tailor their approach, and as such, it results in a waste of valuable resources with unsuccessful campaigns that do not reach the most appropriate consumer. Furthermore, because these companies rely on their employees to target businesses for deals, there is significant cost to procure these types of deal-of-the-day campaigns.

Like deal-of-the-day websites and applications, loyalty programs are often developed with good intentions but unclear objectives. While retail loyalty programs have many purposes, the greatest value that is created for retailers is the ability to identify individual customers and to measure and understand their individual behaviors. This consumer behavior data far outweighs the “currency” value of providing consumers the opportunity to build a reward opportunity by shopping at one particular merchant. This opportunity is often misunderstood by merchants and consumers alike. Often times, many customers are unaware of when they reach an award plateau and never utilize the reward.

In addition, cross-promotions and in some cases rewards programs suffer similar draw backs as loyalty programs in that many times, consumers don't know when these promotions can be redeemed or that they even exist at all. For example, a credit card sponsored by an airline may reward the user with airline miles that may be redeemed for free or discounted travel, but the user may not know that they are eligible for such travel, or may not know that the miles will expire before they have a chance to use them.

Even more, many merchants do not offer reward or loyalty programs for various different reasons, whether they find that it is cost prohibitive or they do not have the proper market data (which is also expensive in and of itself) to fully understand the need and benefit of one.

Accordingly, there is a need for a system and method to notify, offer and award certain discount offers that are optimized based on user behavior and other inputs, while concurrently optimizing merchant discount offers in real-time and providing an incentive for both consumers and merchants alike to utilize the system.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow chart illustrating a method by which users can source merchants to participate in a deal-listing platform and reward program in accordance with one embodiment of the present invention;

FIG. 2 is a flow chart further illustrating a method for optimizing discount programs in accordance with one embodiment of the present invention;

FIG. 3 is a flow chart illustrating a method for merchants to build their own goods and/or service listing using the platform in accordance with one embodiment of the present invention;

FIG. 4 is a flow chart illustrating the points reward program in accordance with one embodiment of the present invention;

FIG. 5 is a block diagram illustrating the platform in accordance with one embodiment of the present invention;

FIG. 6 is a block diagram illustrating the platform integrated with a partner system in accordance with one embodiment of the present invention;

FIG. 7 a block diagram illustrating an alternative integration of the platform with a partner system in accordance with one embodiment of the present invention;

FIG. 8 a schematic block diagram depicting an exemplary deal filtering system in accordance with one embodiment of the present invention.

FIG. 9 is a schematic block diagram depicting an exemplary client/server system which may be used by an exemplary networked embodiment of the present invention;

FIG. 10 a flowchart depicting a method for providing offers in accordance h an embodiment of the present invention.

Unless otherwise indicated illustrations in the figures are not necessarily drawn to scale.

### SUMMARY OF THE INVENTION

To achieve the forgoing and other aspects and in accordance with the purpose of the invention, a method, system and mobile application for increasing value to a user and merchant is presented.

In an embodiment of the present invention, a method for developing discount offers to consumers on a network is provided. The method is executed by one or more computing processors and computer hardware and describes receiving, at a server, at least an input from each of a merchant client in communication with the server over the network; a merchant finder client in communication with the server over the network, generating a unique identification code for the merchant finder client in response to the input from the merchant finder client; outputting the unique identification code to the merchant finder client; generating an interface for the merchant client, the interface configured to allow a merchant to establish and optimize a discount offer for the consumer; upon a purchase of the discount offer by the consumer, receiving the unique identification code, assigning a value to the merchant finder client based on the purchase. A system of developing discount offers is further provided.

In an embodiment of the present invention, a system for developing discount offers to consumers on a network, the system executed by one or more computing processors and computer hardware, the system comprising, a server configured to receive at least an input from each of a merchant client in communication with the server over the network; a merchant finder client in communication with the server over the network; a goods and services engine in communication with the server, wherein the goods and services engine is configured to receive the discount offers input from the merchant client; a rewards management engine configured to receive an input from the merchant finder client, and assign the merchant finder client a unique identification code; wherein when the unique identification code is received by the server and connected to a purchase of the discount offer by the consumer, a value is assigned to the merchant finder client based on the purchase.

The present invention also provides a merchant with inexpensive or free advertising and marketing of their goods and/or services being offered for sale, utilizing the strength of a social network, along with the guarantee that they will only have to share a portion of their income with the referring user and platform if they are able to sell their good and/or service through the platform.

Since, in accordance with the present invention, the referral payments are only made at the time the merchant is successful in selling its goods and/or services through the platform, and with the merchant receiving the money from selling its goods and/or services prior to being required to make any referral payments, the merchants thereby receive the revenue from the sale of the goods or services in advance of being required to make a referral payment and therefore will not have to incur any pre-paid out-of-pocket costs for the advertising or marketing. Accordingly, a merchant can list their items on the platform, thereby garnering additional advertisement and marketing of their goods and/or services for free, knowing they will only have to pay the referral fee if they are in fact successful in selling their listed goods and/or services in the application.

With user referrals as the primary method for souring merchants to join the application to sell its goods and/or services, and with the incentive based system in place, users will focus on merchants that they frequent often and believe will be profitable through the platform, thereby providing the merchant with free feedback about its customer base directly from their customers.

The present invention describes a referral program used in conjunction with the rewards system described herein. In the referral program, users are encouraged to sign-up merchants to sell their goods and/or services and offer rewards as part of the system described herein. If a referred merchant signs-up to use the rewards system described herein, then the user who referred such merchant will receive a predetermined percentage of any sales such merchant makes while utilizing the system. In addition, the user will also receive points from the system operator that can be used to reclaim other prizes and rewards, as further described herein.

The present invention also describes an exchange program in which users and merchants alike can exchange points for rewards or a chance to play games to win larger prizes. Accordingly, merchants will collect points any time a user purchases the merchants' goods and/or services through the application and can redeem those points for rewards such as free advertisement or free listings for its goods and/or services sold through the application; on the other hand, users will collect points any time a purchase is made from one of the merchants they referred and can redeem those points for rewards such as discounts or to play games at a chance to win larger prizes.

The present invention further describes matching users to relevant goods or services in conjunction with the reward system described herein. By obtaining information about or from users, including but not limited to, their demographic information, likes, dislikes, average spending rate, previous purchases, reviews, etc., merchants can tailor their offerings to be more relevant or important to a user and therefore have a better chance of making a sale. In local settings, specified geo-fencing can be used as well.

Information about users can be obtained in many ways, including but not limited to, a user profile that is created by the user whereby the users are required to input certain personal information, culled from previous purchases the users made, from any ratings left by users on any goods or services purchased, from previous prizes the user claimed, etc. Once information about a particular user is known, the goods/services as well as the rewards offered to that user can be more relevant and more likely accepted.

Furthermore, tools can be used to incorporate variables or restraints thereby limiting or expanding the number of customers to which a reward may be offered, such as no greater than X users will be offered this particular reward. By optimizing the rewards across all users, these constraints can be used to attain particular business goals, and can be optimized by the merchant.

Other features, advantages, and aspects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

While exemplary embodiments of the present invention will be described with reference to certain types of mobile applications, a skilled artisan will realize that embodiments of the invention are applicable to any type of mobile application and/or web module in which quantitative analyses on user value is beneficial.

As used herein, a “client” represents a user device that may be used as a platform for audio-visual media such as games, mobile applications, books, movies, music and web content. In the current embodiment, the clients are smart phones. In other embodiments, however, a client may also include personal digital assistants, tablet devices, e-readers, wireless music devices and any other personal computing device such as desktops and laptops, which includes at least one of a display, processor, memory or input or output means. In operation, the user connects to an application store (e.g., Apple App Store®, Android Market®, MiKandi®, Amazon App Store® and BlackBerry App World®), and the application is fully downloadable and integratable into any type of client.

As used herein, a “merchant finder” is any user of the platform who sources a merchant to sign up and utilize the platform to list and sell its goods and/or services. Each merchant finder is assigned a unique identification code that the merchant will be required to enter into the platform during sign-up. The unique identification code will properly track all sales made by the merchant who the merchant finder signed up, and in turn, will track the total amount of referral fees the merchant finder will receive from any sales the merchant it referred makes.

As used herein, a “merchant” is a seller using the platform to drive its deal offerings and rewards programs. The merchant may sell goods and/or services to consumers through the platform and may be either an individual or entity that provides goods or services to a consumer. The merchant may be local, national or global in terms of the geography in which the merchant provides its products or services, and the merchant may be solicited for the platform or may hear of the platform and may approach the platform's provider without being solicited.

As used herein, an “offer” is a good or service at a price that the merchant extends to a user. In an exemplary embodiment, an offer can be as simple as the ability to purchase a specific good at a predetermined price.

As used herein, the “platform” shall mean the application in its final form that is accessed and used by any of its users. In the current embodiment, the platform is a mobile application but other embodiments may be non-downloadable or downloadable computer software. As used herein, a “consumer” is any retail shopper who utilizes the platform to purchase the goods and/or services promoted therein. A consumer can also include a merchant finder if such individual also purchases goods and/or services promoted within the platform.

As used herein, “Reward Points” are operator gift certificates that can be used by the user with participating merchants. For example, Reward Points can be used by consumers and merchant finders to purchase goods and/or services available on the platform; whereas merchants can use Reward Points to reduce listing costs or obtain free advertisements within the platform.

As used herein, a “user” is anyone who utilizes the application, and includes the consumers, merchant finders and merchants.

A first embodiment of the present invention will be described which provides means and methods for optimizing targeting users for deals and operating a rewards platform on a mobile based platform.

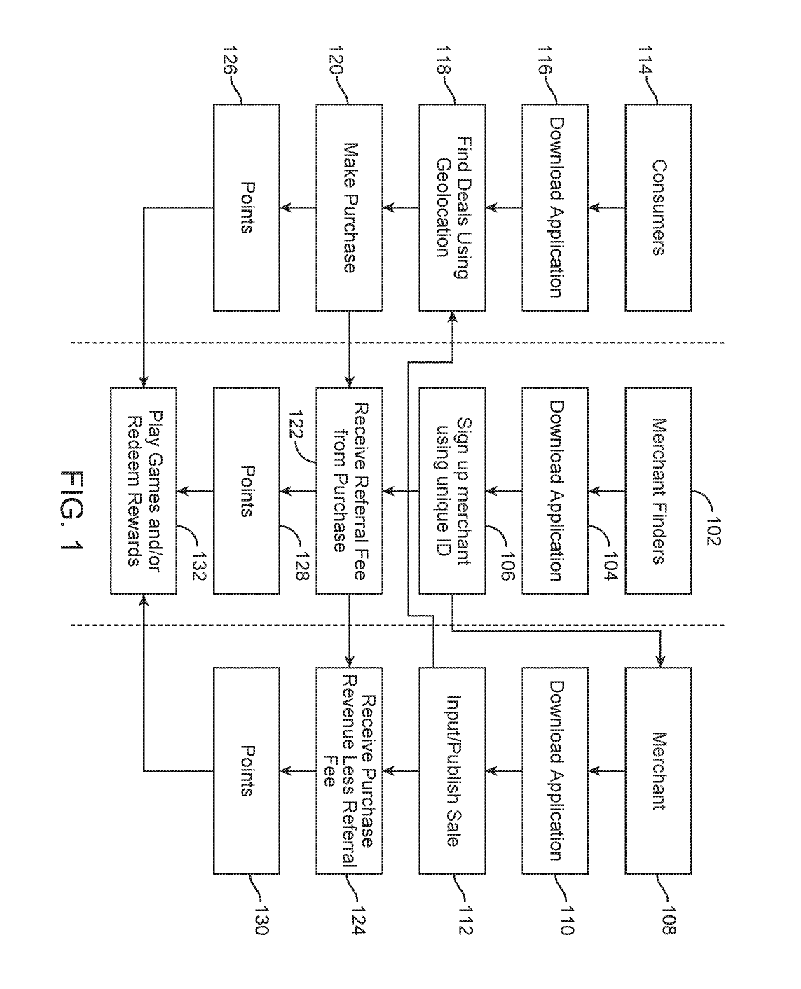

Referring now to FIG. 1, a detailed flow chart illustrating a method by which users can source merchants to participate in a deal-listing and reward program platform in accordance with one embodiment of the present invention is shown generally at 100. In this way, the platform organically develops a purchasing cooperative or “co-op” amongst its various users.

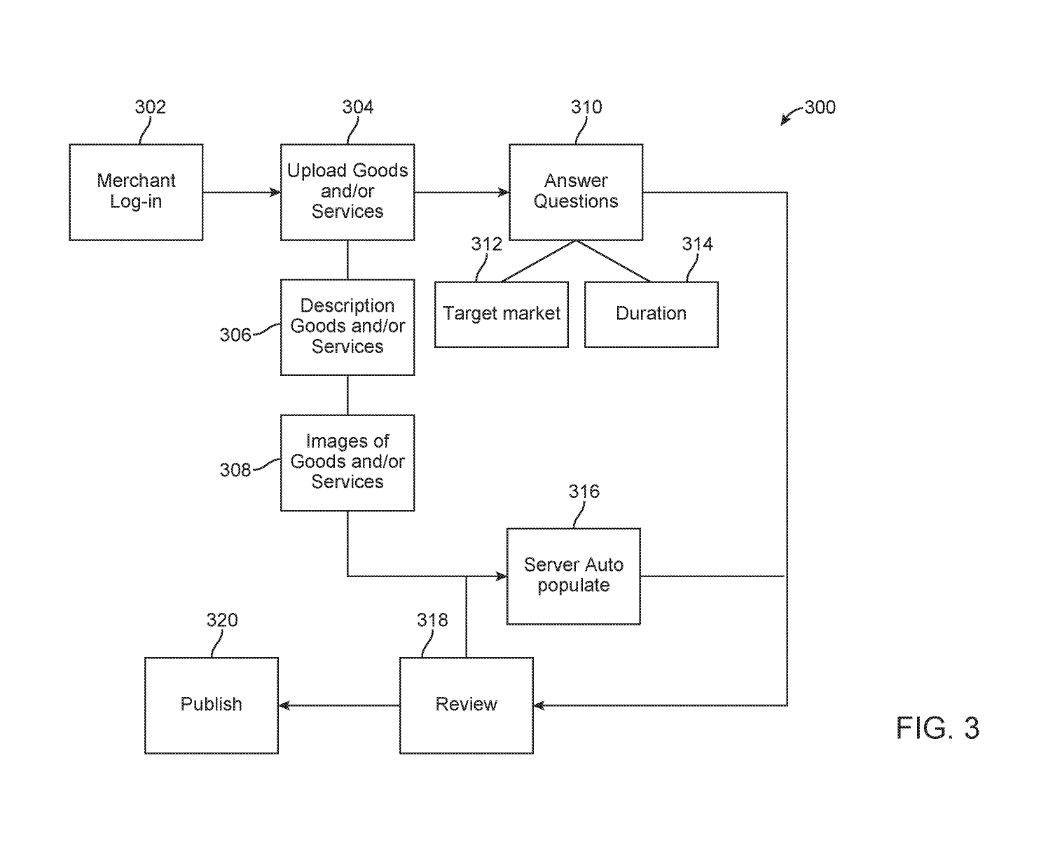

As shown, FIG. 1 is split up into consumers 114, merchant finders 102, and merchants 108, with each having their own portal (or the ability to toggle through which group the user fits into) and each having various interactions occurring between the groups to build the purchasing co-op. In some embodiments, the merchant finders 102 download the application 104 onto its client. While downloading the application 104, the merchant finder 102 may be required to input personal information including, but not limited to, their full name, location, age, sex and shopping habits. In addition, once the merchant finder 102 downloads the application 104 the merchant finder will be assigned a unique identification code that can be used to sign-up a merchant 106. Once merchant finders 102 sign up a new merchant 108 using their unique identification code 106, the merchant 108 will become a part of the platform and will be required to download the application 110 as well, in some embodiments. When a merchant downloads the application 110 it will also be required to input personal information including, but not limited to, its full name, location, type of goods and/or services sold. Once a merchant 108 has successfully downloaded the application 110 it can then use the platform to input and publish its goods and/or services for sale 112, where it can use an optimizer to set certain deals, which is discussed later in greater detail with relation to FIG. 3.

Still referring to FIG. 1, the consumers 114 may download the application 116 as well. While downloading the application 116, the consumer 114 may be required to input personal information including, but not limited to, their full name, location, age, sex and shopping habits. Once the consumer 114 successfully downloads the application 116 they can begin utilizing the platform to find deals using geolocation 118, or in some instances, geofencing. Many times, the deals will be for or located in brick and mortar shops, and thus localized in nature. In this way, the platform may be in communication with the user and the global positioning system of their client, updating location information in real time. As such, the system finds deals using geolocation 118 based on a combination of user data and merchant data.

Still referring to FIG. 1, once a consumer 114 finds a good or service it would like to purchase, it can make the purchase 120. At the time the purchase is made 120, the merchant finders 102 will receive the referral fee 122 directly from the amount collected from such purchase, with the operators of platform receiving a percentage of the sale (e.g., 3-4%) to be billed to the merchant at a later time based on sales factors. Once a sale is completed and the appropriate referral fees and profit is dispersed, the consumers 114, merchant finders 102 and merchant 108 will each receive points 126, 128 and 130, respectively, which can then be used to play games and/or redeem rewards 132. The games that can be played as well as the rewards that may be redeemed will further be discussed herein.

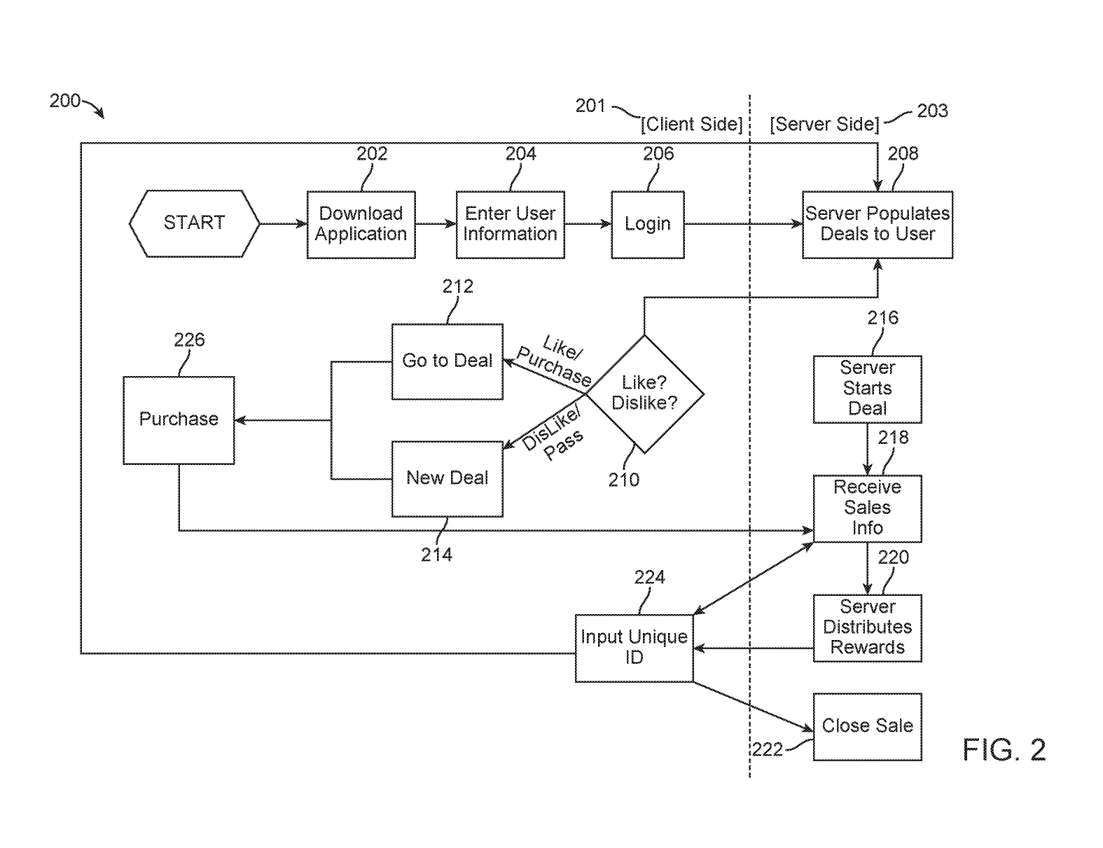

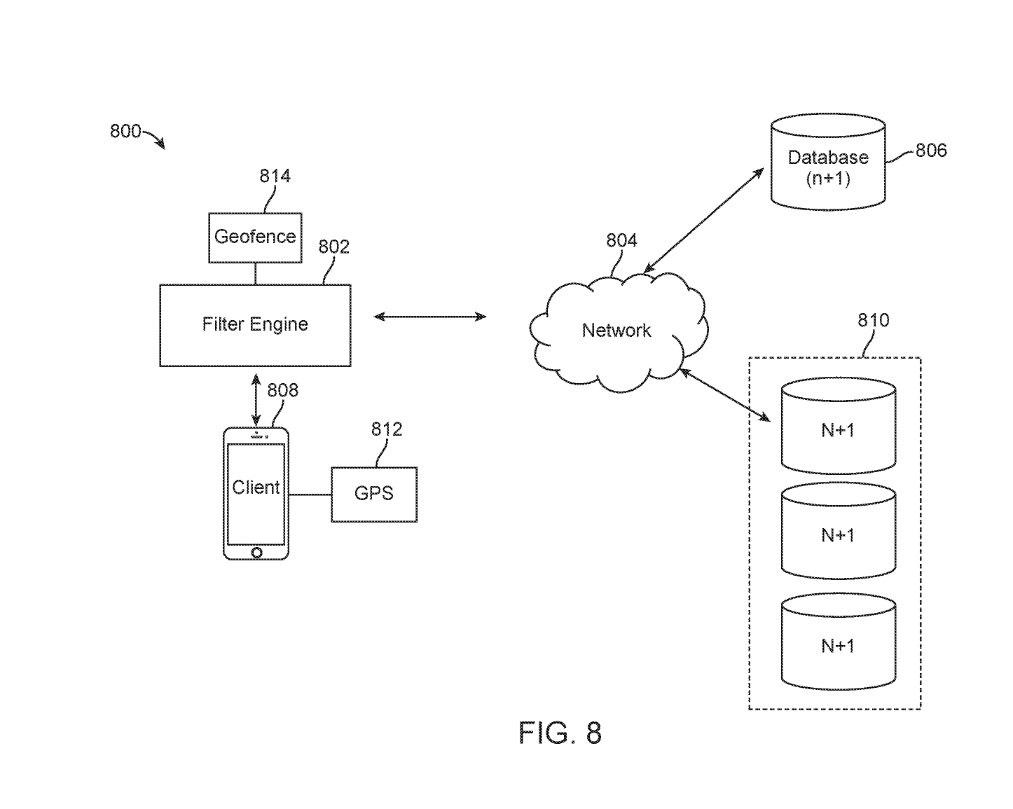

Referring now to FIG. 2, a flow chart further illustrating a method for optimizing reward programs using gaming in accordance with one embodiment of the present invention is shown at numeral 200. The method, executed by the application below with reference to FIG. 8, will be described with a client side 201 and a server side 203.

At step 202, a user downloads the application on the user's client, which is a smart phone device in this exemplary embodiment. In operation, the user connects to an application store (e.g., Apple App Store®, Android Market®, MiKandi, Amazon App Store® and BlackBerry App World®) and the gaming application is downloaded and integrated into any type of client.

At step 204, the user may enter personal information in the dialog boxes. Personal information may include its name, phone number, interests, likes, dislikes and other information such as an address or an opt-in to geo-location services. A user profile may also include the language spoken by a user, duration of time spent and frequency of time in the online environment, and duration of time spent within a sub location within the platform.

At step 206, the user may log in to the platform using its user name and password. The user can then sign up merchants to the platform or shop for deals as described in FIG. 1.

Once merchants log on as well, at step 208, the server is configured to pull input data from step 206, the inputs comprising user information, and merchant deal information. The merchant can build deals on the platform, and the server or server array is configured to populate those deals on the system. Further, once populated, if a user comes within X area of a that deal, for example, a 3 mile radius of the brick and mortar store, the server is configured to notify that user of that deal if the server decides that the deal is attractive to the use based on his or her input data and immediately have deals the user finds attractive pushed or SMS texted to the user. This, in turn, increases user retention for the operator and merchant.

In this embodiment, if a user makes a purchase or likes or dislikes a deal 210, they can earn a varying level of Reward Points. If they like the deal, they can then go to deal page 212. If they dislike it, they can toggle through additional deals based on input parameters and merchant and/or platform selected geolocation or geofencing 214.

The user can then make a purchase 226 based on the deal they like or find persuasive. The server receives sale information and the unique ID from the merchant at 218 as inputs from the merchant from block 224. The rewards are also distributed to the users by the server at block 220 based on the inputs of the ID and purchase information. At step 222, the server may close out a deal based on a response from the merchant.

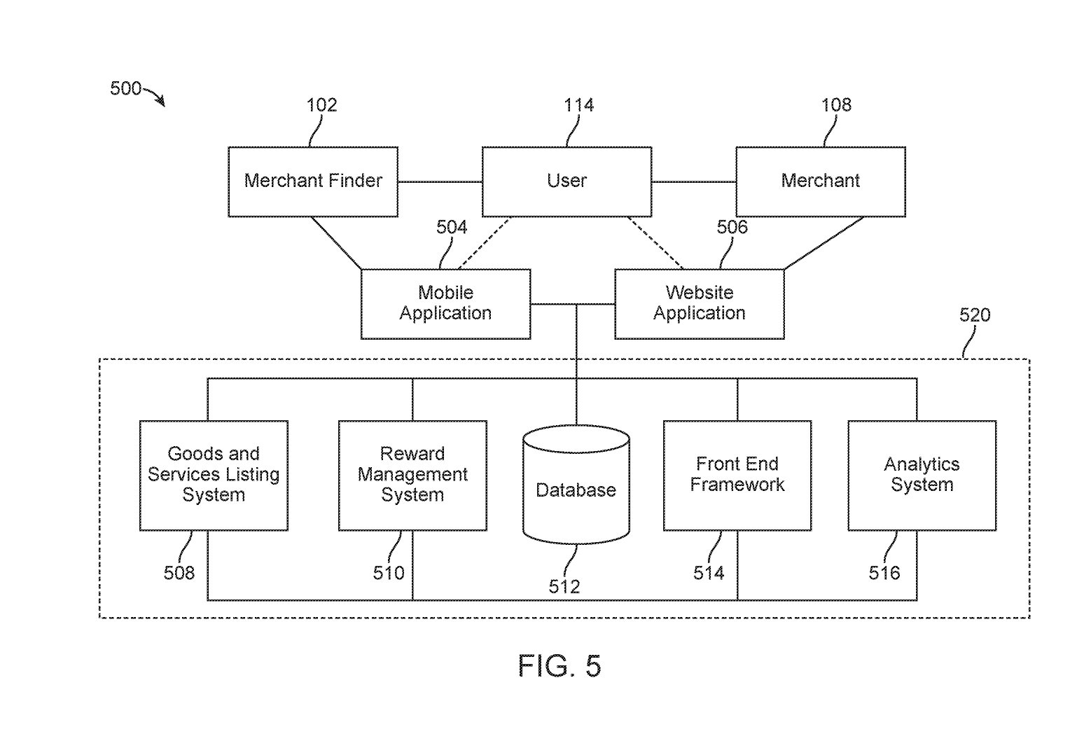

Further, and as described in more detail with relation to FIG. 5, the server may be in communication with the merchant's advertising networks and exchanges. In some embodiments, a merchant may manipulate their content on the platform directly, or the operator may do it on the merchant's behalf. In other embodiments, the platform may be directly integrated with an advertisement network or ad-exchange, such that the content will pass through other external systems before being displayed on the platform.

Referring now to FIG. 3, a flow chart showing a method for a merchant to build their own “daily deal”, or goods and/or service listing using the platform, in accordance with one embodiment of the present invention is shown generally at 300. In this embodiment, the merchant logs into their account at step 302 using a graphical user interface (GUI). The merchant will then be prompted by the server to upload its offers goods and/or services in step 304. When uploading its offers for goods and/or services in step 304, the merchant will be required to provide certain information such as a description of the goods and/or services, step 306, as well as images of the goods and/or services, step 308. At step 310 the server will prompt the merchant with a set of questions relating to the uploaded goods and/or services. The questions may include pertinent information that will allow the server to properly generate a listing, such as the merchant's target market 312 and the duration of the listing 314. Once the information is gathered, the server may auto-populate a listing 316, which in some embodiments, are white labeled. At step 318, the merchant may review the listing and if acceptable, can publish to the application at step 320.

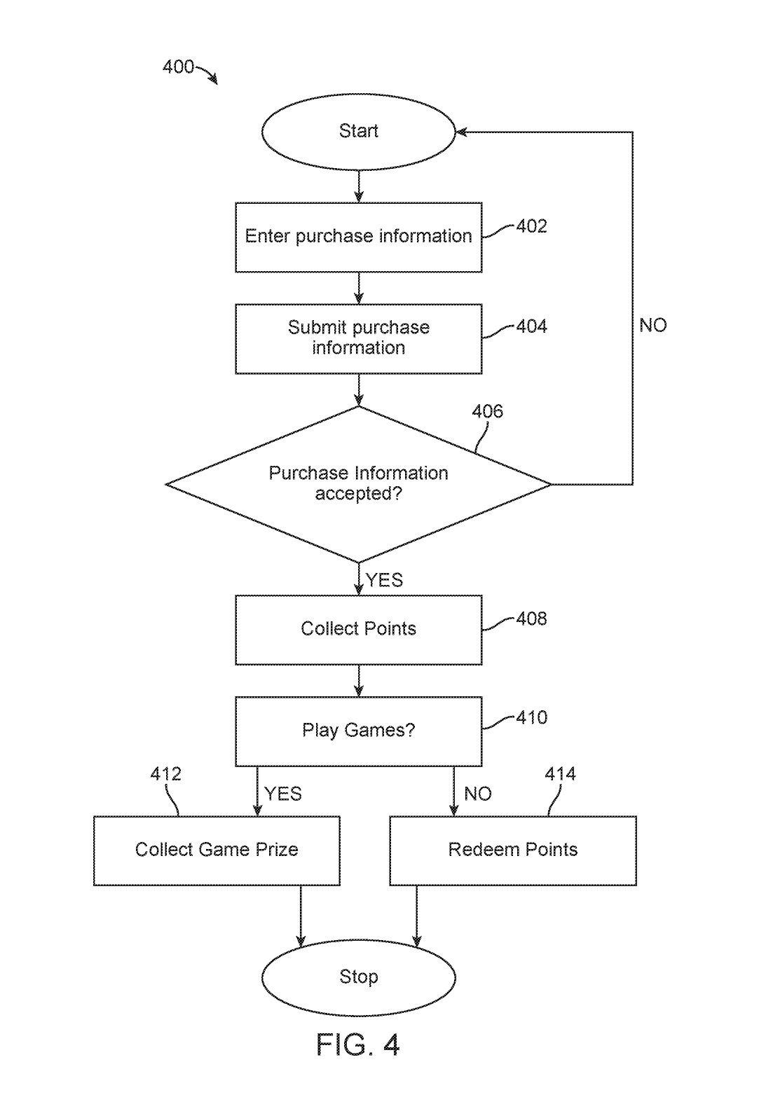

Referring now to FIG. 4, a flow chart illustrating the points reward program in accordance with one embodiment of the present invention is shown generally at 400. When a sale is executed (see 120 in FIG. 1), the purchaser information is entered in step 402. In the present embodiment, purchaser information includes the quantity, sales price and payment information for the goods and/or services purchased. After the purchaser information is entered at step 402, it is then submitted to the server in step 404. After submission in step 404, the server will determine whether the purchase is accepted or not in step 406. If the purchaser information is not accepted in step 406, then the consumer must reenter the purchaser information in step 402. Purchaser information may not be accepted if, for example, the credit card, billing information or shipping address is incorrect. If and when the purchaser information is accepted, the users will be rewarded points 408. Once a user collects points in step 408, it can then elect whether or not to use those points to play a game in step 410 at a chance to win larger prizes with a bigger payout 412; in the alternative, the user can elect to not play any games and instead redeem its points for Reward Points in step 414.

Still referring to FIG. 4, whenever any item is purchased by a consumer, both the merchant finder and the merchant will receive points in step 408, which they can all in turn use to play the game in step 410 or elect to forego playing of the games and collect a lesser prize as part of step 414. For example, the consumers and merchant finders may be able to redeem their points for coupons or reward certificates which may be used to purchase other goods and/or services available on the platform; merchants will be able to utilize their points to redeem reduced listing fees and free advertisements as a few examples of the various things they can do with their points.

According to the preferred embodiment, two levels of rewards are contemplated. One level of reward available to those that play the games are called “high risk” rewards and offer the user the chance at winning a high value item. For example, a user may be able to play a game to earn a “high risk” reward such as plane tickets or super bowl tickets. Another level of reward available to those that do play the games are called “no risk” rewards, which are smaller prizes and may include coupons or gift certificate that can be used on the platform, thereby removing the risk associated with playing a “high risk” game where you have a chance to win a large prize or significantly reduced prize. In this current embodiment, one “low risk” reward that is available will be the Reward Points that are operator issued gift certificates that can be redeemed with any merchant enrolled on the platform. In addition, if a user elects to play a “high risk” reward game and is not successful, they may still receive Reward Points but at a lower level than they would have received if they simply accepted the “no risk” reward and did not play a game. For example, an unsuccessful player of a game for a “high risk” reward may still receive 10 Reward Points, whereas the same user would have received 20 Reward Points if it foregoes playing a game and accepted the “no risk” reward.

Referring now to FIG. 5, a block diagram illustrating the platform in accordance with one embodiment of the present invention is shown generally at 500. The platform as shown can be a mobile application 504 or a website application 506. The user 114, merchant 108 and merchant finder 102 can interact with either or both. The mobile application 504 and the website application 506 are both in communication with the goods and services listing system 508, the reward management system 510, the database 512, the front-end framework (e.g., the GUI) 514 and the analytics system 516. A website host 520 (e.g., server array) may operate as a cloud computing service for communication between components and users. There are various companies that may be used as the host, which include but are not limited to, Amazon AWS®, Microsoft Azure®, IBM Cloud®, Google Cloud Platform®, Rackspace®, GoDaddy®, Oracle Cloud® or 1&1®. Each of the analytics system 516, reward management system 510, database 512, front end framework 514 and the goods and services listing system 508 function like their analogous components specified in the previous FIGS.

Still referring to FIG. 5, the goods and service listing system 508 may comprise, for example, a content management application (CMA) configured as a front-end user interface that allows a merchant to add, modify and remove content from the platform without the intervention of a webmaster. It may also comprise a content delivery application (CDA) that compiles information and updates the application or website, or a digital asset management (DAM) system configured to manage and publish media.

Still referring to FIG. 5, the reward management system 510 may comprise, for example, a CMA configured as a front-end user interface that allows a merchant to add, modify and remove certain rewards or points available to users on the platform without the intervention of a webmaster. It may also comprise a CDA that compiles information concerning the redemption rates of rewards and points, updating the availability of the foregoing on the platform, or a DAM configured to manage and publish the goods and services automatically.

In one preferred embodiment, points are collected at an amount of one point per one cent such that a consumer purchasing a good and/or service over the platform for $10.00 will receive 1,000 points. In one embodiment, the points may only be redeemed through the platform and cannot be exchanged for cash.

The goods and services listing system 508 may comprise the functionality required to perform the methods shown in FIGS. 2-3, in that it can, without limitation, track purchases and perform certain geo-fencing operations where needed.

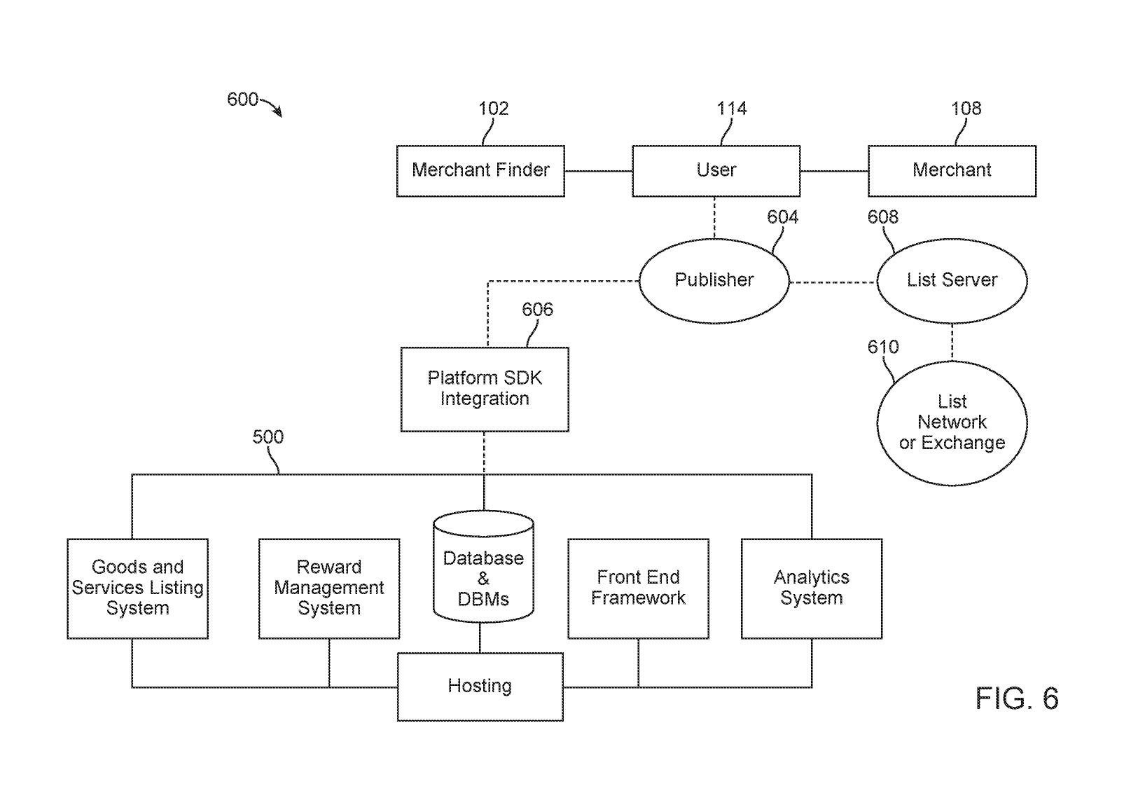

Referring now to FIG. 6, a block diagram illustrating the platform 500 integrated with a partner system in accordance with one embodiment of the present invention is shown generally at 600. In this embodiment, the platform 500 is provided via integration through a software development kit (SDK) 606 to be able to display the platforms in listing format to the user 114, merchant 108 and merchant finder 102. In exemplary embodiments, the merchant 108 may want an external source such as a publisher 604 to set up its deals and advertisements to make it more attractive to the users. In this way, a publisher 604 may interact with external participants such as list servers 608 and list exchanges and networks 610 to determine what goods and services (in the list format) should be served to a user based on information about the user that the publisher 604 has. As such, the publisher 604 is in communication with the listing server 608 which places the listings on the platform. The list exchange 610 is in communication with the list server 608 in this embodiment. In other embodiments, it is also possible to include ad servers to interact with the publisher for purposes of placing advertisements most correlated to the users most likely to purchase the listed goods and services.

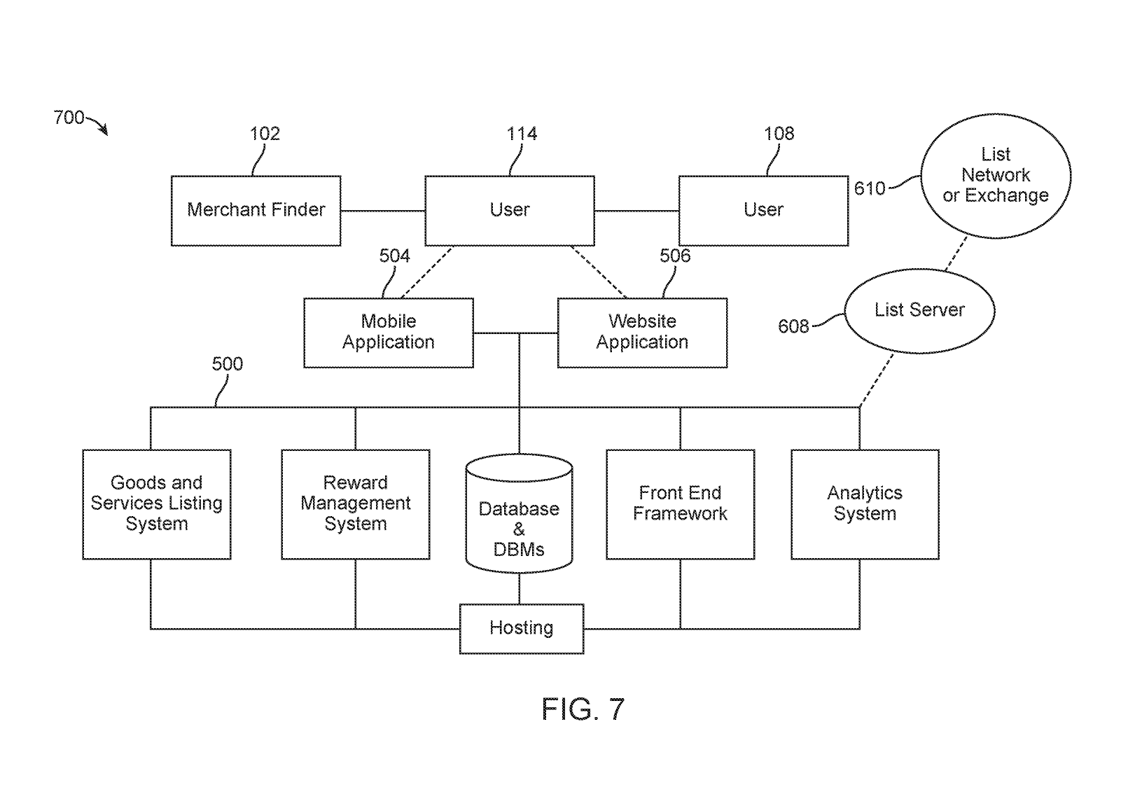

Referring now to FIG. 7, a block diagram illustrating the integrated platform of FIG. 6, except that the list server 608 and list network 610 is in communication with the platform 500, is shown in accordance with one embodiment of the present invention generally at 700. In this embodiment, the platform 500 is interacting with external participants, such as list servers 608 and the exchanges and networks 610 to determine what goods and services should be made available to a user 114, merchant 108 and merchant finder 102. In other embodiments, it is also possible to include ad servers to interact with the publisher for purposes of placing advertisements most correlated to the users most likely to purchase the listed goods and services.

Referring now to FIG. 8, a schematic block diagram depicting an exemplary deal filtering system which may be used together with an exemplary embodiment of the present invention is shown generally at 800.

As shown, the system comprises a filter engine 802, network 804, and databases 806 (n+1). A client 808 is also shown in communication with the network 804 through the filer engine 802. Client 808 represents a user devices (e.g., smartphones) through which one or more independent users may be in communication with the server at filter engine 802. Further, it should be noted that while only one client 808 is shown, the present methods and systems are applicable to large volume networks in the order of hundreds of thousands or millions of clients.

The filter engine 802 may be part of a server-side system which comprises a single processor or multiple processors, micro-controllers (e.g., with embedded RAM/ROM) and microprocessors such as programmable devices (e.g., RISC or CISC based, or CPLDs and FPGAs) and devices not capable of being programmed such as gate array ASICs (Application Specific Integrated Circuits) or general purpose microprocessors. The filter engine 802 is configured to receive and filter deals and offers based on a plurality of inputs by users together with the information provided by client-side databases to optimize the deal-flow to a particular user. The filter engine 802 may be configured to be controlled by a user such that the user is not over-burdened with indicia and messages regarding deals that are appropriate for them. The user has the ability to set the type of deal the user is looking for and the frequency of notices concerning those types of deals as well.

The filter engine 802 is communicably coupled to the global network 804 and also to a client 808. Global network 804 may communicate bi-directionally with geo-fence 814 and the client 808 through the filter engine 802. The global network 804 may comprise the Internet, local area networks (LANs), wide area networks (WANs), wired telephone networks, wireless networks, or any other network supporting data communication between respective clients, developers, servers, and the like. The client 808 may further comprise a GPS 812

Referring still to FIG. 8, database 806 is in communication with the filter engine 802 through the network 804. In exemplary embodiments, the databases may also be in communication with a plurality of merchant databases 810, represented as n+1. For example, databases 810 may comprise a credit card merchant database, a travel merchant database, a retail merchant database and an educational institution database. Each of the databases hold information that is relevant to the consumer. Besides the normal input information such as name, date of birth, gender, and the like, the databases also hold information regarding certain promotions and deals that are being offered or are available to the account holder or user. The databases may comprise records containing information for providing promotions to a user based on the status of promotions previously delivered to the user through other means as well. The information may comprise promotion identifiers of promotions delivered to a user, the delivery date of the promotion, the medium through which the promotion was delivered, and the status of the promotion as well as status criteria for determining the status of a promotion, and related promotions delivered based on the status of a previous promotion. Records in the databases comprise fields together with a set of operations for searching, sorting, recombining, and other database functions as will become further apparent below.

In a first exemplary embodiment, the user may not be taking advantage of the promotion simply because the account holder is unaware it's available to them. By way of example, a user may have a card that is connected to a credit card database. In a predetermined month, the credit card company may be offering a cross-promotion in which the user receives free internet Wi-Fi through, for example, Boingo®. The filter engine 802 is configured to retrieve this data from the database 806 (n+1), sort the promotion amongst a plurality of other promotions, and notify the user that this promotion is available to them at an optimized time. By optimized time, it is meant that the offer will be presented to the user at a time in which the user is most likely to take advantage of the deal or offer. In this exemplary embodiment, once the user is in the airport, using geospatial or geofencing and location placement via the user's smart phone (client), the filter engine will retrieve and send message regarding the offer to the user through the mobile application. In this way, the user will know not to pay for the service, but rather, to use the free promotion.

In another exemplary embodiment, the user may have booked travel using a travel website. In some instances, there are cross-promotions with hotel and/or car rental companies. In this exemplary embodiment, the filter engine 802 is configured to retrieve this data from the database 806 (n+1) through the global network 804, sort the promotion amongst a plurality of other promotions, and notify the user that this promotion is available to them at the time of the travel ticket purchase. The filter engine 802 may further provide a list of merchants available to use, and directly link to those merchants. Furthermore, as in the previous exemplary embodiment, once the user is approaching a hotel or car rental merchant, using geospatial and location placement via the user's smart phone, the filter engine will retrieve and send message regarding the offers to the user through the mobile application (e.g., upon arrival at the airport or rental car space).

In another exemplary embodiment, the user may have an account with a retail store, for example, Macy's®. The filter engine 802 is configure to, on a real-time basis, collate deals and sales in Macy's® stores. The filter engine 802 is configured to sort these deals according to use inputs and other variables and key performance indicators. When a user is at a predetermined radius to the retailer, the filter engine 802 will notify the user through the mobile app that these deals are available on that day.

In another exemplary embodiment, the user may be a university that has student identification cards (ID) that can be used to purchase items on campus. A student ID may, in certain circumstances, have cross-promotions with local restaurants and on-campus stores. The filter engine 102 is configure to, on a real-time basis, collate these promotions and sort these deals according to use inputs and other variables and key performance indicators and notify the user through the mobile app that these deals are available on that day.

In optional embodiments of the present invention, a user may query the server for deals in his or her area. For example, the user may be in an area for which they are unfamiliar. A user may query the server for deals in that area that match up to their profile. The server may then output the deals to the users that are available in that area.

In other optional embodiments of the present invention, a merchants may opt for a flash sale. As an example, assume a restaurant has no reservations for a night. Using the merchant side of the application, the merchant may input a sale or discount to the system on the server side, and the system will output message to those users that are appropriate. This gives merchant a level of control unrealized by past approaches.

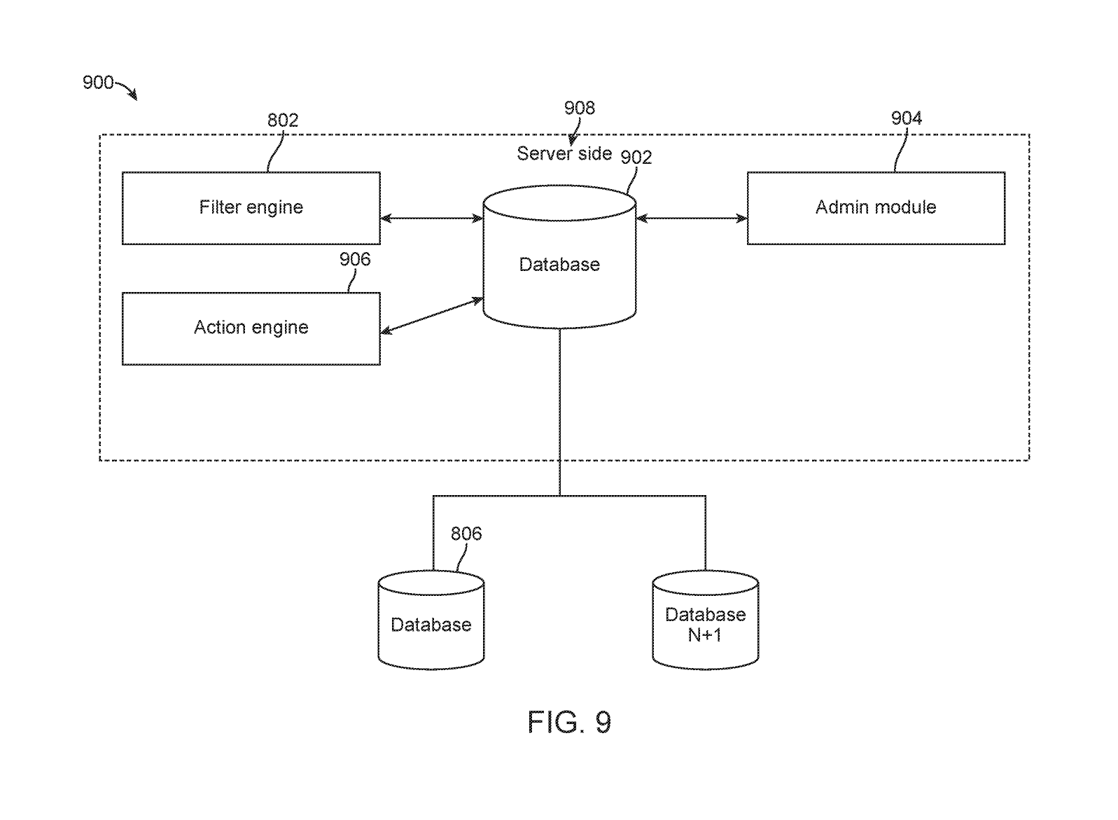

Referring now to FIG. 9, a schematic block diagram showing the server side/client side interaction in which the client side represents merchants in accordance with one embodiment of the present invention is shown generally at 900. In this embodiment, the database 902 and filter engine 802 on the server side 908 is configured to collect and collate information from the client side regarding promotions, deals and the like. As shown, the server side 908 comprises a server-side database 902, filter engine 802, admin module 904 and action engine 906. It should be noted that while only one server is shown, the system may further comprise a plurality of servers.

In exemplary embodiments of the present invention, the admin module 904 is in communication with the filter engine 802 through the database 902, and is configured to allow for highly targeted advertising by merchants. For example, the admin module 904 may utilize a plurality of input key performance indicators so as to set trigger values for which a merchant can specifically target a user, as opposed to a general “scatter-gun” email approach in which all users are targeted. In this way, promotions and discounts can be constantly updated and revised based on the data received by the server. In exemplary embodiments, the admin module 904 can rely on a variety of inputs and performance data for these specific targets, such as user demographics and purchase history, and the like, as well.

The action engine 906, which is also in communication with the database 902, is configured to make consistent queries for certain user behaviours, location and data. For example, the action engine 906 may be configured to monitor which offers a user is viewing on the application, and perform a comparative analysis with the data sets gathered from the databases 806 (n+1), and further calculate average revenue per user (ARPU), in any predetermined period of time, ARPU by demographic (e.g., country, sex, age, and combinations thereof), mean/median purchases, and the like. The above-described indicia may be combined with solutions which are intrinsically defined by user behaviour and user inputs.

Furthermore, the server-side 908 may be configured as a learning machine. For example, the components may act together to such that they are configured to be predictive based on the data received from the action engine.

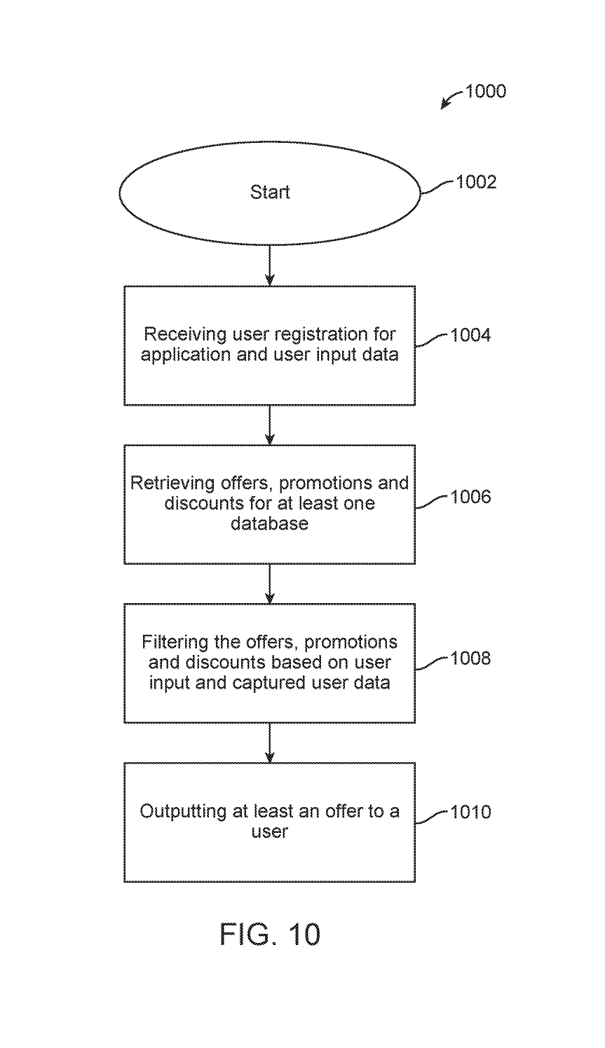

Referring now to FIG. 10, a flowchart depicting a method for providing offers in accordance with an embodiment of the present invention is shown generally at 1000.

At step 1002, the process starts. At step 1004, the server is configured to receive a user download of the platform. In addition, at step 1004, the server receives user input data.

At step 1006, the server is configured to retrieve offers, promotions, and discounts from at least one database or merchant.

As step 1008, the server is configured to filter the offers, promotions and discounts based on user input and captured user data.

At step 1010, the server is configured to output at least one offer based on the filtering at step 1008.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

We claim:

1. A method for developing discount offers to consumers on a network, the method executed by one or more computing processors, the method comprising:
receiving, at a server, at least an input from each of:
a merchant client in communication with the server over the network;
a merchant finder client in communication with the server over the network;
generating a unique identification code for the merchant finder client in response to the input from the merchant finder client;
outputting the unique identification code to the merchant finder client;
generating an interface for the merchant client, the interface configured to allow a merchant to establish and optimize a discount offer for a consumer;
upon a purchase of the discount offer or a discounted item by the consumer, receiving the unique identification code at the server;
assigning a value to the merchant finder client based on the purchase.

2. The method of claim 2, further comprising:
receiving a first location information from a consumer client via consumer client global positioning unit;
receiving a second location information from the merchant client via merchant client global positioning unit;
constructing a geofence based on the received first and second location information, wherein an operator, the merchant client, or both, can construct the geofence.

3. The method of claim 1, wherein the value received by the merchant finder client is monetary, rewards points, or both.

4. The method of claim 1, wherein the merchant client and the consumer client each receive value for purchases made by the consumer client, wherein the value received by the merchant client finder is monetary, rewards points, or both.

5. The method of claim 1, wherein the value is redeemable used to play merchant sponsored games, redeem rewards or receive cash back.

6. The method of claim 1, further comprising receiving personal information for each consumer client, generating a profile, and using the profile to match consumer clients with a discount offer of interest.

7. The method of claim 6, further comprising tracking the consumer client using the consumer client GPS, and automatically notifying the consumer client when they are in a geofence in which the discount offer of interest is located.

8. The method of claim 1, wherein generating an interface for the merchant client comprises:
prompting a merchant using the merchant client to upload an image its goods or services;
prompting the merchant to described the goods or services;
providing a set of queries to the merchant based on the type of goods or services;
generate a listing based on the responses to the queries;
publishing the listing with merchant approval.

9. The method of claim 1, wherein when a purchase of the discount offer is made the by the consumer, the merchant client inputs a unique merchant ID, the quantity, and total purchase price of goods or services for the discount offer sold, this information being received by the server, and applied to the merchant finder client.

10. The method of claim 1, further comprising:
based on input from the consumer client, receiving at the server a plurality of promotions that the consumer client already has based on prior conduct;
storing the promotions in a database;
notifying the user when the promotion is available for use based on the location of the consumer client.

11. A system for developing discount offers to consumers on a network, the system executed by one or more computing processors, the system comprising:
a server configured to receive at least an input from each of:
a merchant client in communication with the server over the network;
a merchant finder client in communication with the server over the network;
a goods and services engine in communication with the server, wherein the goods and services engine is configured to receive the discount offer input from the merchant client;
a rewards management engine configured to receive an input from the merchant finder client, and assign the merchant finder client a unique identification code;
wherein when the unique identification code is received by the server and connected to a purchase of the discount offer by the consumer client, a value is assigned to the merchant finder client based on the purchase.

12. The system of claim 11, wherein the system further comprises an action engine configured to:
receive a first location information from a consumer client via global positioning unit;
receive second location information from the merchant client via global positioning unit;
construct a geofence based on the received first and second location information, wherein an operator client, merchant client, or both, can construct the geofence.

13. The system of claim 11, wherein the value received by the merchant finder client is monetary, rewards points, or both.

14. The system of claim 11, wherein the merchant client and the consumer client each receive value for purchases made by the consumer client, and wherein the value received by the merchant finder client is monetary, rewards points, or both.

15. The system of claim 11, wherein the value is redeemable and used to play merchant sponsored games, redeem rewards or cash back.

16. The system of claim 11, further comprising a filter engine configured to receive personal information for each consumer, generate a profile, and use the profile to match consumers with a discount offer of interest.

17. The system of claim 12, wherein the action engine is further configured to track the consumer using the consumer client GPS, and automatically notify the consumer when they are in a geofence in which a discount offer of interest is located.

18. The system of claim 11, wherein the interface to allow a merchant to establish and optimize a discount offer is configured to:
prompt the merchant using the merchant client to upload an image its goods or services;
prompt the merchant to described the goods or services;
provide a set of queries to the merchant based on the type of goods or services;
generate a listing based on the responses to the queries;
publish the listing with merchant approval.

19. The system of claim 11, wherein when a purchase of the discount offer is made the by the consumer client, the merchant client enters a unique merchant ID, the quantity, and total purchase price of goods or services for the discount offer sold, this information being received by the server, and applied to the merchant finder client.

20. The system of claim 16, wherein the filter engine is configured to:
based on input from the consumer, receive at the server a plurality of promotions that the consumer client already has based on prior conduct;
store the promotions in a database;
notify the user when the promotion is available for use based on the location of the consumer client.
